(19) United States
(12) Patent Application Publication
(10) Pub. No.: US 2012/0030595 A1
(43) Pub. Date: Feb. 2, 2012

(54) INFORMATION STORAGE MEDIUM, TERMINAL APPARATUS, AND IMAGE GENERATION METHOD

(75) Inventors: Kyosuke Itahana, Matsumoto-shi (JP); Mitsuru Kubota, Matsumoto-shi (JP); Tomohiro Nomizo, Shiojiri-shi (JP); Issei Yokoyama, Matsumoto-shi (JP)

(73) Assignee: Seiko Epson Corporation, Tokyo (JP)

(21) Appl. No.: 13/192,604

(22) Filed: Jul. 28, 2011

(30) Foreign Application Priority Data
Jul. 29, 2010 (JP) 2010-170621
Jul. 29, 2010 (JP) 2010-170622

(51) Int. Cl. G06F 3/048

(52) U.S. Cl. 715/765

(57) ABSTRACT

In an information storage medium in which a program readable by a computer is stored, the program allows the computer to execute generating a configuration change image containing an individual image based on image information from one or more terminal apparatuses and containing an individual image arrangement area showing arrangement of the individual image in an overall image displayed by a display apparatus and an icon arrangement area containing an icon with respect to each terminal apparatus for changing a configuration of the overall image, changing a display condition of the individual image arrangement area based on operation information representing operation relating to a configuration change of the overall image, and changing an icon background image on a background of the icon or a form of the icon in response to the display condition.

The entire disclosure of Japanese Patent Application Nos. 2010-170622 filed Jul. 29, 2010 and 2010-170621, filed Jul. 29, 2010 are expressly incorporated by reference herein.

### BACKGROUND

1. Technical Field

The present invention relates to an information storage medium, a terminal apparatus, and an image generation method.

2. Related Art

For example, Patent Document 1 (JP-A-2004-54783) discloses a display system of receiving captured image data that have been subjected to size conversion processing from plural terminal apparatuses, synthesizing the data into image data for one screen, and displaying it. Further, Patent Document 1 also discloses that an image of a specific terminal apparatus is enlarged and displayed, deleted, or added according to operation by a user with a remote controller of a display apparatus.

However, for example, in a conference or the like, when a presenter enlarges an image in a terminal apparatus used by a participant or the like in response to a request from the participant, the presenter should specify the image, understand the request, and perform remote controller operation in response to the request, and the operation takes time. Further, Patent Document 1 discloses that a split screen for enlarged display or the like can be designated from the terminal apparatus side, however, does not disclose any specific method. Furthermore, when a participant uses his/her terminal apparatus to make configuration change of the image displayed on the display apparatus or the like, it is necessary to appropriately grasp the current display condition, however, it is difficult to grasp which terminal apparatus provides the image being used from the image displayed on the display apparatus. In addition, in order that the participant may grasp the condition of the terminal apparatus that can display but is not being used for display, the participant should confirm detailed information and several steps are necessary for obtaining the information, and time and effort are required.

### SUMMARY

An advantage of some aspects of the invention is to provide an information storage medium, a terminal apparatus, and an image generation method that can indicate a current display condition promptly and appropriately in the case where an overall image containing individual images based on image information from terminal apparatuses is displayed by a display apparatus, when a configuration of the overall image is changed.

An aspect of the invention is directed to an information storage medium in which a program readable by a computer is stored, and the program allows the computer to execute generating a configuration change image containing an individual image arrangement area showing arrangement of an individual image in an overall image displayed by a display apparatus and an icon arrangement area containing an icon with respect to each terminal apparatus for changing a configuration of the overall image, the individual image is based on image information from one or more terminal apparatuses, changing a display condition of the individual image arrangement area including an assignment condition of a mark image corresponding to the icon in the individual image arrangement area based on operation information representing operation relating to the configuration change in response to operation relating to each icon, and generating the configuration change image with an icon background image on a background of the icon or a form of the icon changed in response to the display condition.

Another aspect of the invention is directed to a terminal apparatus including an image generation unit that generates a configuration change image containing an individual image based on image information from one or more terminal apparatuses for changing a configuration of an overall image displayed by a display apparatus, and an input unit to which operation information representing operation relating to the configuration change is input, wherein the configuration change image contains an individual image arrangement area showing arrangement of the individual image in the overall image and an icon arrangement area containing an icon with respect to each terminal apparatus, the operation information is input to the input unit in response to the operation relating to each icon, and the image generation unit changes a display condition of the individual image arrangement area including an assignment condition of a mark image corresponding to the icon in the individual image arrangement area based on the operation information and generates the configuration change image to change an icon background image on a background of the icon or a form of the icon in response to the display condition.

Still another aspect of the invention is directed to an image generation method of generating a configuration change image containing an individual image based on image information from one or more terminal apparatuses for changing a configuration of an overall image displayed by a display apparatus. The terminal apparatus generates the configuration change image for containing an individual image arrangement area showing arrangement of the individual image in the overall image and an icon arrangement area containing an icon with respect to each terminal apparatus, and, when operation information representing operation relating to the configuration change in response to operation relating to each icon, changes a display condition of the individual image arrangement area including an assignment condition of a mark image corresponding to the icon in the individual image arrangement area based on the operation information, and changes an icon background image on a background of the icon or a form of the icon in response to the display condition.

According to the aspects of the invention, the terminal apparatus or the like generates the configuration change image containing the individual image arrangement area showing arrangement of the individual image in the overall image displayed by the display apparatus, and thereby, may present the configuration of the overall image in an easy-to-understand manner. Further, according to the aspects of the invention, the terminal apparatus etc. change the display condition of the individual image arrangement area in response to the operation, and thereby, even in the case where the configuration of the overall image is changed, may promptly reflect the change on the display of the individual image arrangement area. Furthermore, according to the aspects of the invention, the terminal apparatus etc. change the icon or the icon background image as an object of operation in response to the display condition of the individual image arrangement area, and thereby, the user becomes easier to visually grasp the display condition and able to perform prompt operation.

Further, according to the aspects of the invention, the terminal apparatus etc. change the icon background image or the like in response to three conditions, and thereby, the user becomes easier to visually grasp the display condition and operate when performing operation relating to the icon in response to the display condition.

Furthermore, according to the aspects of the invention, the terminal apparatus etc. determine whether or not the individual image is displayed based on the operation information representing the position of the cursor image and the operation information representing press-down operation of the display mode button image, and thereby, the user may change the display of the individual image by various operations, and further, promptly change the configuration of the overall image.

### BRIEF DESCRIPTION OF THE DRAWINGS

The invention will be described with reference to the accompanying drawings, wherein like numbers reference like elements.

FIG. 1 shows a display status of an overall image in the first embodiment.

FIG. 2 is a functional block diagram of a projector in the first embodiment.

FIG. 3 is a functional block diagram of a PC in the first embodiment.

FIG. 4 is a flowchart showing an image display procedure of the PC in the first embodiment.

FIG. 5 is a flowchart showing an image display procedure of the projector in the first embodiment.

FIG. 6 is a sequence chart showing exchanges of information between the PC and the projector in the first embodiment.

FIG. 7 shows an example of a search image in the first embodiment.

FIG. 8 shows an example of a configuration change image in the first embodiment.

FIG. 9 shows an example of image transitions in the respective apparatuses in the first embodiment.

FIG. 10 shows another example of image transitions in the respective apparatuses in the first embodiment.

FIG. 11 shows another example of image transitions in the respective apparatuses in the first embodiment.

FIG. 12 shows an example of a configuration change image in other embodiments.

### DESCRIPTION OF EXEMPLARY EMBODIMENTS

As below, embodiments in which the invention is applied to a PC (Personal Computer) or the like will be explained with reference to the drawings. Note that the following embodiments do not limit the subject matter of the invention described in the appended claims. Further, all of the configurations shown in the following embodiments are not necessarily essential as solving means of the invention described in the appended claims.

### First Embodiment

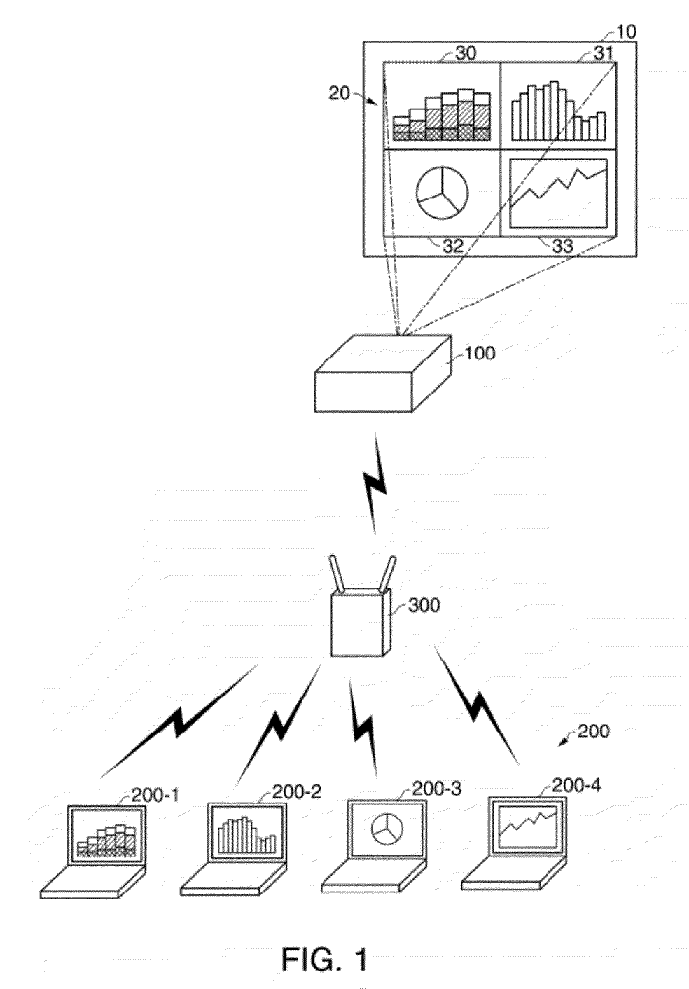

FIG. 1 shows a display status of an overall image 20 in the first embodiment. In the embodiment, one projector 100 and four PCs 200-1 to 200-4 are wirelessly connected via an access point 300. The projector 100 projects the overall image 20 containing the four individual images 30 to 33 at the maximum based on image information from the respective PCs 200 on a screen 10. For example, a participant who participates in a conference can change the configuration of the individual images 30 to 33 in the overall image 20 by operating an icon of a configuration change image displayed on his/her PC 200 or the like. Note that the projector 100 is a kind of display apparatus, the PC 200 is a kind of terminal apparatus, and the projector 100 and the respective PCs 200 may be provided in the same room or provided in different rooms. Next, functional blocks of the projector 100 and the PC 200 having the functions will be explained.

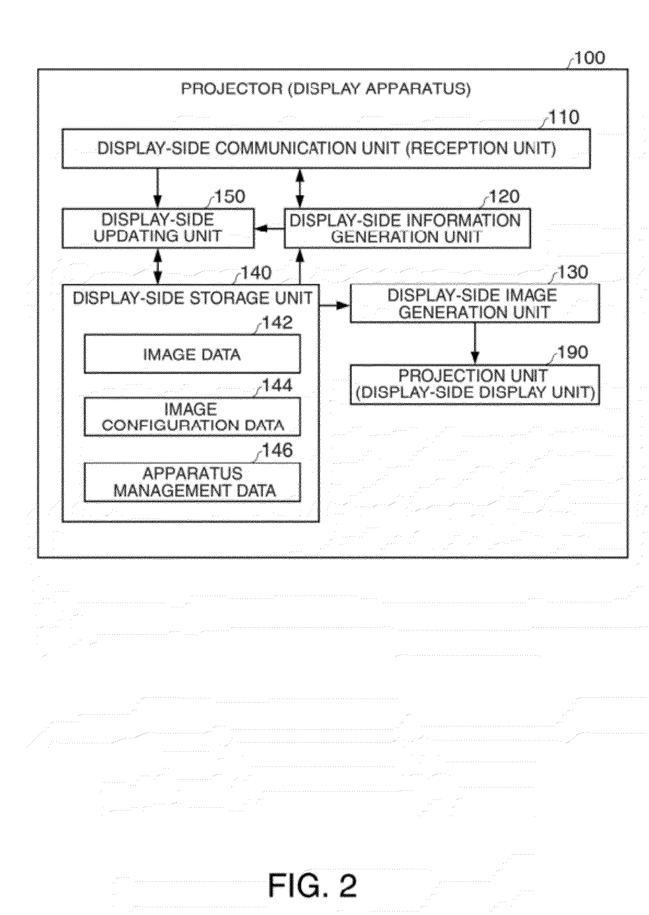

FIG. 2 is a functional block diagram of the projector 100 in the first embodiment. The projector 100 includes a display-side communication unit 110 that makes communication with the PC 200 via the access point 300, a display-side information generation unit 120, a display-side image generation unit 130, a display-side storage unit 140, a display-side updating unit 150 that updates data within the display-side storage unit 140, and a projection unit 190 as a kind of display-side display unit. Further, the display-side storage unit 140 stores image data 142 representing image information from the PC 200 and the like, image configuration data 144 representing configurations of the overall image 20 and the configuration change image, apparatus management data 146 representing an apparatus as a target of communication, etc. Note that the display-side communication unit 110 is a kind of reception unit that receives image information or the like from the PC 200.

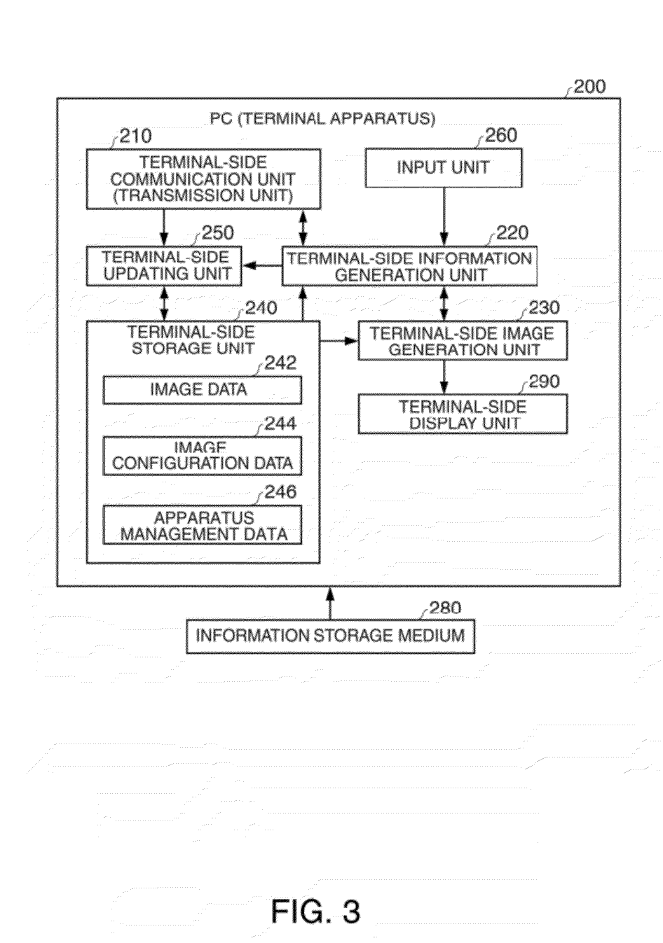

FIG. 3 is a functional block diagram of the PC 200 in the first embodiment. The PC 200 includes a terminal-side communication unit 210 that makes communication with the projector 100 via the access point 300, a terminal-side information generation unit 220, a terminal-side image generation unit 230, a terminal-side storage unit 240, a terminal-side updating unit 250 that updates data within the terminal-side storage unit 240, and a terminal-side display unit 290. Further, the terminal-side storage unit 240 stores image data 242 representing image information and the like, image configuration data 244 representing a configuration of the configuration change image, apparatus management data 246 representing an apparatus as a target of communication, etc. Note that the terminal-side communication unit 210 is a kind of transmission unit that transmits image information or the like to the projector 100.

Further, the projector 100 and the PC 200 may function as the respective units using the following hardware. For example, the projector 100 and the PC 200 may use the display-side communication unit 110, the terminal-side communication unit 210 may use a wireless communication unit or the like, the display-side information generation unit 120, the display-side updating unit 150, the terminal-side information generation unit 220, and the terminal-side updating unit 250 may use CPUs or the like, the display-side image generation unit 130 and the terminal-side image generation unit 230 may use an image processing circuit or the like, the display-side storage unit 140 and the terminal-side storage unit 240 may use RAMs or the like, an input unit 260 may use a USB (Universal Serial Bus) port or the like connected to a keyboard, a mouse, or the like, the projection unit 190 may use a lamp, a liquid crystal panel, a liquid crystal drive circuit, a lens, or the like, and the terminal-side display unit 290 may use a backlight, a liquid crystal panel, a liquid crystal drive circuit, or the like. Further, the computer of the PC 200 may function as the terminal-side image generation unit 230 or the like by reading a program stored in an information storage medium 280. As the information storage medium 280, for example, a CD-ROM, a DVD-ROM, a ROM, a RAM, an HDD, or the like may be applied.

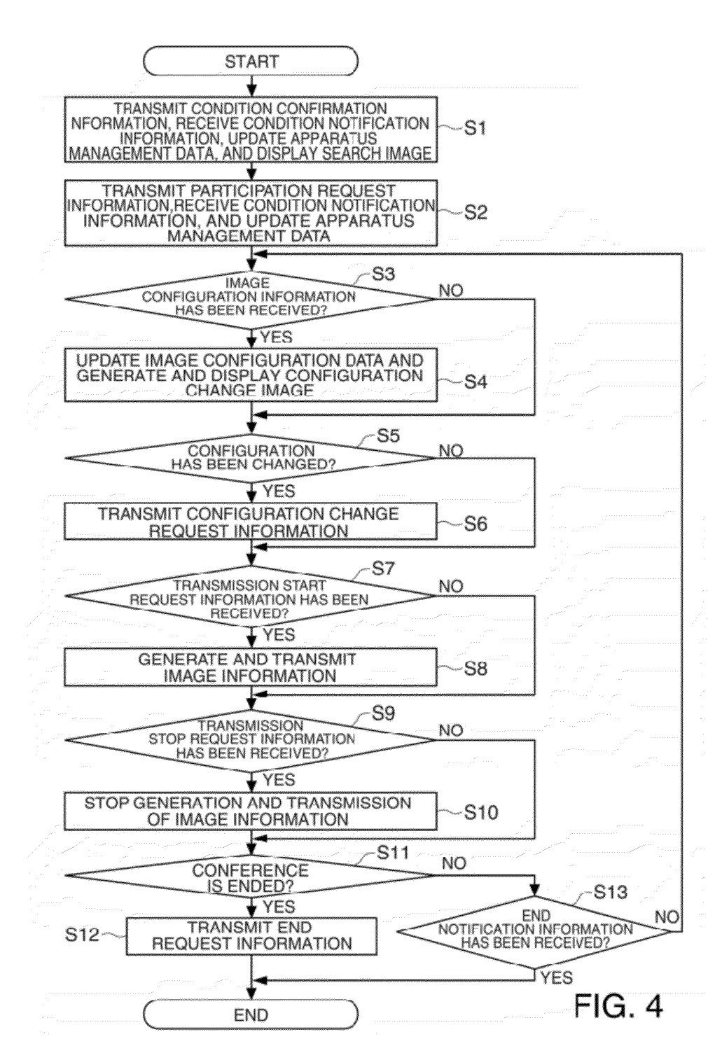

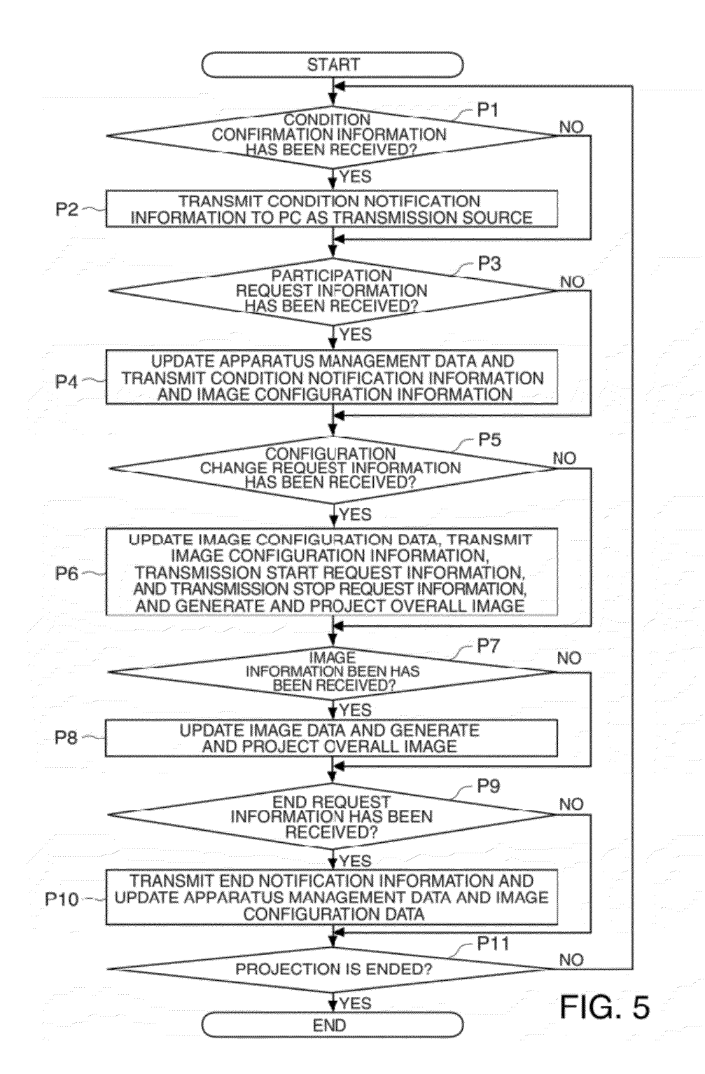

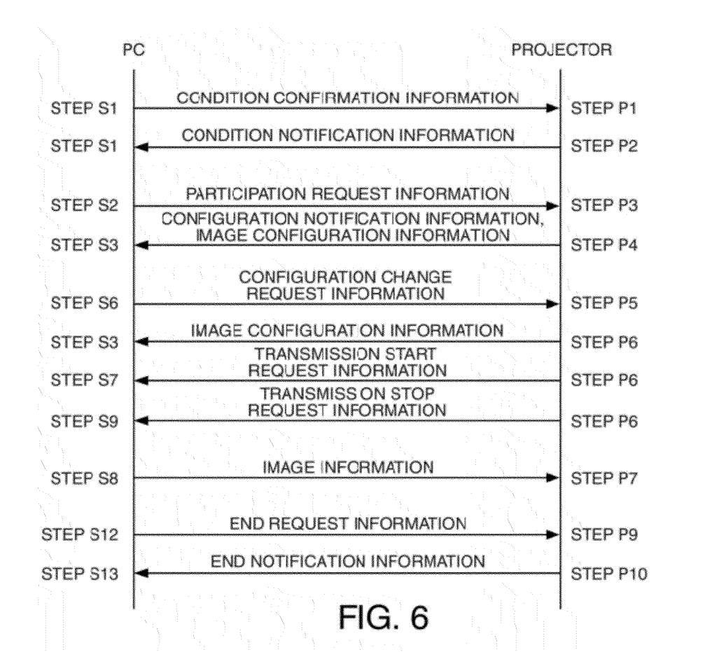

Next, a projection procedure of the overall image 20 in response to a configuration change request of an image using the projector 100 and the PC 200 will be explained. FIG. 4 is a flowchart showing an image display procedure of the PC 200 in the first embodiment. Further, FIG. 5 is a flowchart showing an image display procedure of the projector 100 in the first embodiment. Furthermore, FIG. 6 is a sequence chart showing exchanges of information between the PC 200 and the projector 100 in the first embodiment.

First, using FIG. 4, the image display procedure of the PC 200 will be explained. A participant in a conference provides an execution instruction of a projector search program by operating a keyboard, a mouse, or the like of the PC 200 for connection of his/her own PC 200 to the projector 100. The projector search program has been installed in the PC 200 in advance. The terminal-side information generation unit 220 generates condition confirmation information for confirmation of connection conditions of the respective apparatuses in the network or the like based on information representing the execution instruction from the input unit 260. The terminal-side communication unit 210 transmits the condition confirmation information to the projector 100 and receives condition notification information indicating connection conditions of the respective apparatuses from the projector 100. The terminal-side updating unit 250 updates the apparatus management data 246 based on the condition notification information, the terminal-side image generation unit 230 generates a search image showing a search result of the projector based on the image data 242 and the apparatus management data 246, and the terminal-side display unit 290 displays the search image (step S1).

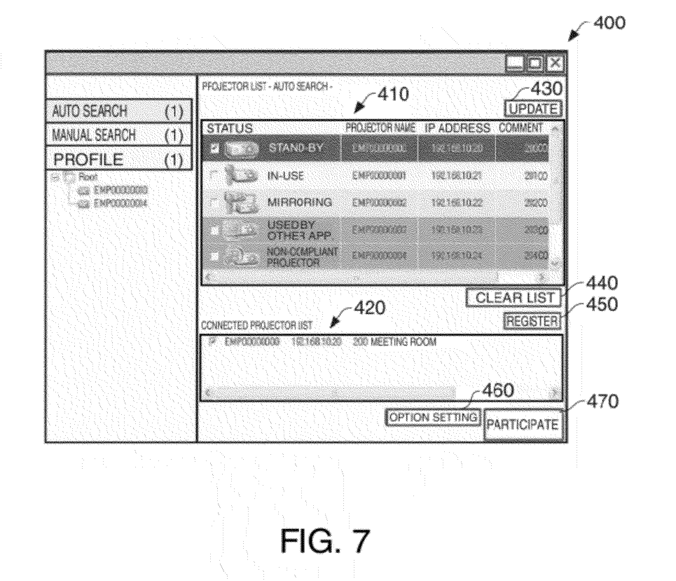

FIG. 7 shows an example of a search image 400 in the first embodiment. The search image 400 is an image displayed on the screen of the PC 200 by execution of the above described projector search program in the PC 200, and contains a search result display area 410 showing conditions of the projectors, names of the projectors, IP addresses etc. represented by the apparatus management data 246, a connected projector list display area 420 showing the projector as a connection destination, an update button image 430 for obtaining the latest search result, a clear button image 440 for clearing the connected projector list display area 420, a registration button image 450 for registration of a new projector in the connected projector list display area 420, an option setting button 460, a participation button image 470 for participating in the conference (connecting the PC 200 to the projector 100), etc.

The participant provides a participation instruction in the conference by clicking the participation button image 470 using the mouse of the PC 200. The terminal-side information generation unit 220 generates participation request information based on information showing the participation instruction from the input unit 260, and the terminal-side communication unit 210 transmits the participation request information to the projector 100 and receives the condition notification information from the projector 100. The terminal-side updating unit 250 updates the apparatus management data 246 based on the condition notification information (step S2).

The terminal-side updating unit 250 determines whether or not the terminal-side communication unit 210 has received image configuration information showing the configuration of the configuration change image from the projector 100 (step S3). When the image configuration information is received, the terminal-side updating unit 250 updates the image configuration data 244 based on the image configuration information. The terminal-side image generation unit 230 generates the configuration change image based on the image configuration data 244, and the terminal-side display unit 290 displays the configuration change image (step S4).

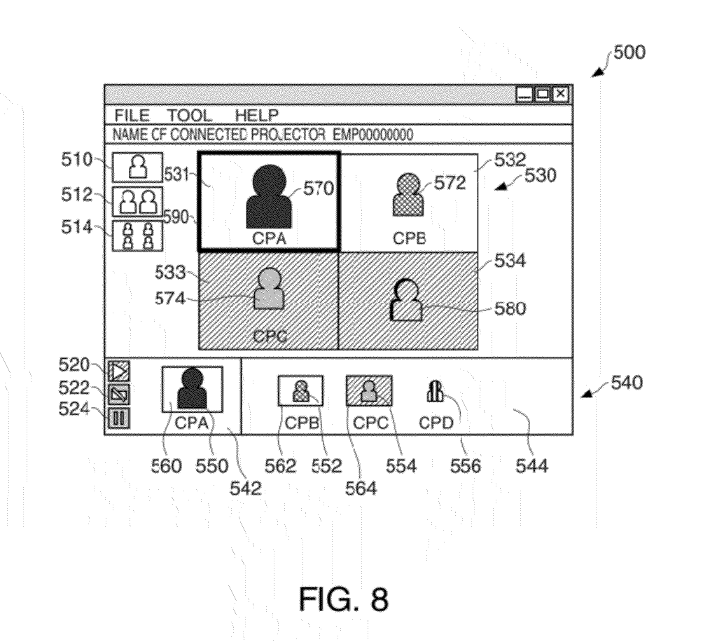

FIG. 8 shows an example of a configuration change image 500 in the first embodiment. The configuration change image 500 contains display mode button images 510 to 514 for changing the number of individual images forming the overall image 20, an individual image arrangement area 530 formed by four display object areas 531 to 534 in two rows and two columns, a display button image 520 for instruction to display of the overall image 20, an image mute button image 522 for providing an instruction to display a user logo image or the like in place of the overall image 20, a pause button image 524 for providing an instruction to maintain the display of the current overall image 20, an icon arrangement area 540 in which icons 550 to 556 are arranged, a rectangular cursor image 590 moving in the display object areas 531 to 534 in response to the operation for selection of the individual image to be displayed, etc. Further, the configuration change image 500 contains a menu image showing “File”, “Tool”, “Help”, an image showing the name of the connected projector, etc.

For example, the configuration change image 500 shown in FIG. 8 is an image displayed on the screen of the PC 200-1 (the computer name is “CPA”). In the individual image arrangement area 530, a mark image 570 showing the CPA is placed in the display object area 531 in the upper left area, a mark image 572 showing the CPB (PC 200-2) is placed in the display object area 532 in the upper right area, a mark image 574 showing the CPC (PC 200-3) is placed in the display object area 533 in the lower left area, and not a mark image is placed, but a recess image of a recessed mark image is placed in the display object area 534 in the lower right area. Further, when displayed in the overall image 20, the backgrounds of the mark images 570 to 574 are displayed in white and, when not displayed, the backgrounds of the mark images 570 to 574 are displayed in gray. For example, in the example shown in FIG. 8, the backgrounds of the mark images 570, 572 are white and that shows two individual images of the PCs 200-1, 200-2 are arranged side-by-side in the overall image 20. Note that the background of the recess image 580 is gray.

Further, in the icon arrangement area 540, in an other apparatus area 544 on the right, the icons 552 to 556 indicating the other PCs 200 are placed from the left in the order of participation (in the order of connection to the projector 100), in an own apparatus area 542 on the left, the icon 550 fixedly indicating the own apparatus is placed regardless of the order of participation. Furthermore, the backgrounds of the icons 550 to 556 change in response to the display condition in the individual image arrangement area 530. For example, in the example shown in FIG. 8, icon background images 560, 562 on the backgrounds of the icons 550, 552 in the display condition in which the mark images are displayed and the individual images are displayed are displayed in white (first condition), an icon background image 564 on the background of the icon 554 in the display-standby condition in which the mark image is displayed, but no individual image is displayed is displayed in gray (second condition), and nothing is displayed on the background of the icon 556 in the non-display condition in which no mark image is displayed (third condition). Further, the icon 550 of the own terminal apparatus is displayed larger than the icons 552 to 556 of the other terminal apparatuses, and the mark image 570 of the own terminal apparatus is displayed larger than the mark images 572, 574 of the other terminal apparatuses. Furthermore, the icons 550 to 556 are respectively displayed in different colors, and the mark images 570 to 574 are respectively displayed in different colors. In addition, the icons 550 to 556 and the mark images 570 to 574 are displayed with host names of the PCs 200 (the names can be set up by the user).

In the embodiment, when the projector 100 and the PC 200 establish connection, first condition notification information containing unique color information to the PC 200 assigned by the projector 100 is notified to the PC 200. Here, the color information is information for designating the colors used for the icon and the mark image, and may be preset numeric values corresponding to colors or text data representing the names of colors. Further, the information may be RGB values expressed by predetermined bit numbers. The PC 200 that has newly established the connection to the projector 100 notifies other PC 200 terminal apparatuses that had already established connection to the projector 100 of second condition notification information containing unique color information to the PC 200 assigned by the projector 100. The other PCs 200 that receive the color information from the PC 200 that has newly established the connection to the projector 100 notify third condition notification information including color information assigned to their own terminal apparatus to the other PCs 200 that have established connection to the projector 100. Thereby, correspondences between the color of the icons placed in the icon arrangement area 540 of the configuration change image 500 and the PC 200 that has established connection to the projector 100 are the same in any PC 200, and, even if plural PCs 200 have established connection to the projector 100, the respective participants can easily specify the desired PCs 200 by the colors of the icons. Note that, in the case where the projector 100 transmits first condition notification information containing color information of all PCs 200, the notification of the third condition notification information is not necessary.

The respective participants who operate the respective PCs 200 can display and operate the search image 400 and the configuration change image 500 on the screens of the respective PCs 200, and, for example, by dragging and dropping the icons 550 to 556 from the icon arrangement area 540 to the individual image arrangement area 530, may change the configuration of the individual image arrangement area 530. For example, each participant places and clicks the mouse pointer over the position of the icon 552 of the PC 200-2 (CPB), moves the mouse pointer to the display object area 532 on the upper right (the icon 552 remains in the icon arrangement area 540 and an icon having the same form as the icon 552 moves in conjunction with the mouse pointer) and pulls his/her finger from the mouse, and thereby, can place the mark image 572 corresponding to the PC 200-2 in the display object area 532 and project the overall image 20 containing the individual image of the PC 200-2 on the projector 100. The terminal-side information generation unit 220 determines whether or not the configuration change operation has been performed based on the information from the input unit 260 (step S5). If the configuration change operation has been performed, the terminal-side information generation unit 220 generates configuration change request information and the terminal-side communication unit 210 transmits the configuration change request information to the projector 100 (step S6).

Further, the terminal-side information generation unit 220 determines whether or not transmission start request information of image information has been received by the terminal-side communication unit 210 from the projector 100 (step S7). If the transmission start request information has been received, the terminal-side information generation unit 220 generates image information representing graphic images etc. shown in FIG. 1 based on the image data 242, and the terminal-side communication unit 210 transmits the image information to the projector 100 (step S8). Note that the terminal-side image generation unit 230 generates the graphic images etc. shown in FIG. 1, and continuously captures the graphic images etc. and stores them as the image data 242 in the terminal-side storage unit 240.

Further, the terminal-side information generation unit 220 determines whether or not transmission stop request information of image information has been received by the terminal-side communication unit 210 from the projector 100 (step S9). If the transmission stop request information has been received, the terminal-side information generation unit 220 stops generation of the image information and the terminal-side communication unit 210 stops transmission of the image information (step S10). Note that, in this case, the terminal-side image generation unit 230 may stop capture of images.

Furthermore, the participant may cut off the communication of his/her own PC 200 by selecting “Exit” from the submenu of the “Tool” of the configuration change image 500, and cut off the communication of all PCs 200 by selecting “End of Conference” from the submenu. The terminal-side information generation unit 220 determines whether or not “End of Conference” has been selected based on the information from the input unit 260 (step S11). If “End of Conference” has been selected, the terminal-side information generation unit 220 generates end request information and the terminal-side communication unit 210 transmits the end request information to the projector 100 (step S12). Further, the terminal-side information generation unit 220 determines whether or not end notification information transmitted from the projector 100 in response to the reception of the end request information has been received by the terminal-side communication unit 210 (step S13). If the PC 200 transmits the end request information or receives the end notification information, the PC 200 ends the above described series of processing and displays the search image 400, and, if the conference is not ended, repeatedly executes the above described processing at steps S3 to S13. Note that, if “End of Conference” has been selected, the terminal-side information generation unit 220 may generate a confirmation image showing a character string that “All users participating in conference will be disconnected from projector and search window will appear again. End conference?”, and, if the end notification information is received, may generate a notification image showing a character string that “Other user has ended conference. Search window will appear again”.

Next, using FIG. 5, the processing procedure in the projector 100 will be explained. The display-side information generation unit 120 determines whether or not condition confirmation information has been received by the display-side communication unit 110 from the PC 200 (step P1). If the condition confirmation information has been received, the display-side information generation unit 120 generates condition notification information based on the apparatus management data 146, and the display-side communication unit 110 transmits the condition notification information to the PC 200 as the transmission source (step P2).

Further, the display-side updating unit 150 determines whether or not participation request information has been received by the display-side communication unit 110 from the PC 200 (step P3). If the participation request information has been received, the display-side updating unit 150 updates the apparatus management data 146 based on the participation request information. Further, in this case, the display-side information generation unit 120 generates condition notification information based on the apparatus management data 146, and generates image configuration information based on the image configuration data 144 in response to the status. The display-side communication unit 110 transmits the condition notification information and the image configuration information to the respective participating PCs 200 (step P4).

Further, the display-side updating unit 150 determines whether or not configuration change request information has been received by the display-side communication unit 110 from the PC 200 (step P5). If the configuration change request information has been received, the display-side updating unit 150 updates the image configuration data 144 based on the configuration change request information. Furthermore, in this case, the display-side information generation unit 120 generates image configuration information based on the image configuration data 144, and generates transmission start request information, transmission stop request information in response to the status. More specifically, for example, if it is necessary to newly display an individual image, the display-side information generation unit 120 generates transmission start request information to the PC 200 as the transmission source of image information of the individual image, and, if it is no longer necessary to display the individual image, generates transmission stop request information to the PC 200 as the transmission source of image information of the individual image. The display-side communication unit 110 transmits the image configuration information, the transmission start request information, and the transmission stop request information to the respective participating PCs 200. Further, the display-side image generation unit 130 generates the overall image 20 based on the image data 142, the image configuration data 144 in response to the image configuration, and the projection unit 190 projects the overall image 20 (step P6).

Furthermore, the display-side updating unit 150 determines whether or not the image information has been received by the display-side communication unit 110 from the PC 200 (step P7). If the image information has been received, the display-side updating unit 150 updates the image data 142 based on the image information. In addition, in this case, the display-side image generation unit 130 generates the overall image 20 based on the image data 142, the image configuration data 144, and the projection unit 190 projects the overall image 20 (step P8).

The display-side information generation unit 120 determines whether or not end request information has been received by the display-side communication unit 110 from the PC 200 (step P9). If the end request information has been received, the display-side information generation unit 120 generates end notification information. The display-side communication unit 110 transmits the end notification information to the respective PCs 200. At the end of the conference, the display-side updating unit 150 updates the apparatus management data 146, the image configuration data 144 to an initial condition or the like, for example (step P10). The projector 100 determines whether or not there has been a projection end instruction (step P11), and, if there has been a projection end instruction, ends the above described series of processing.

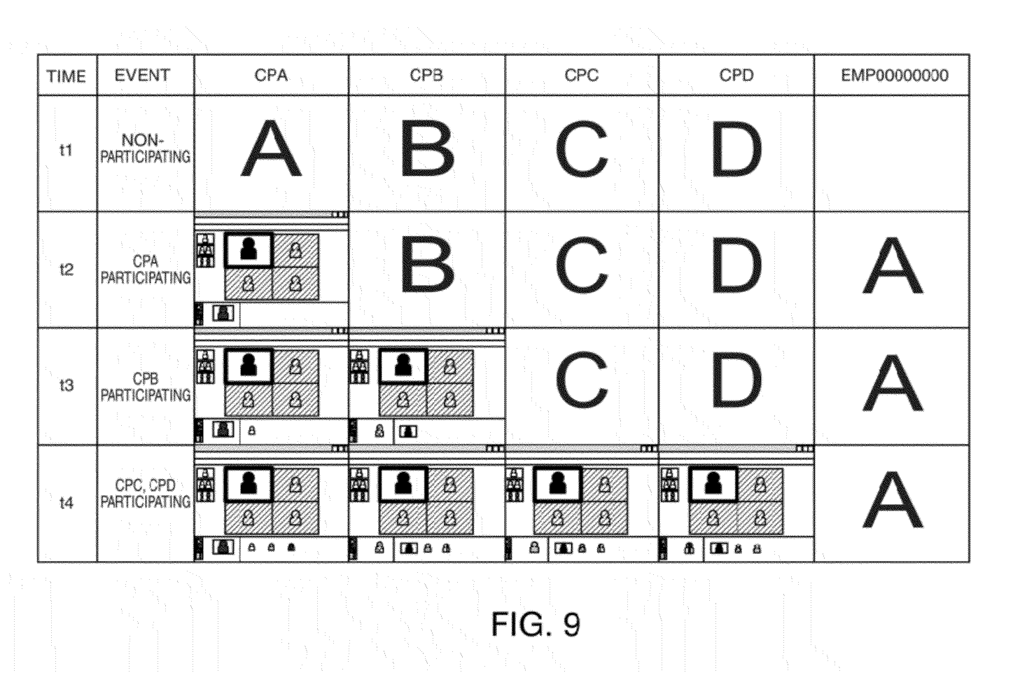

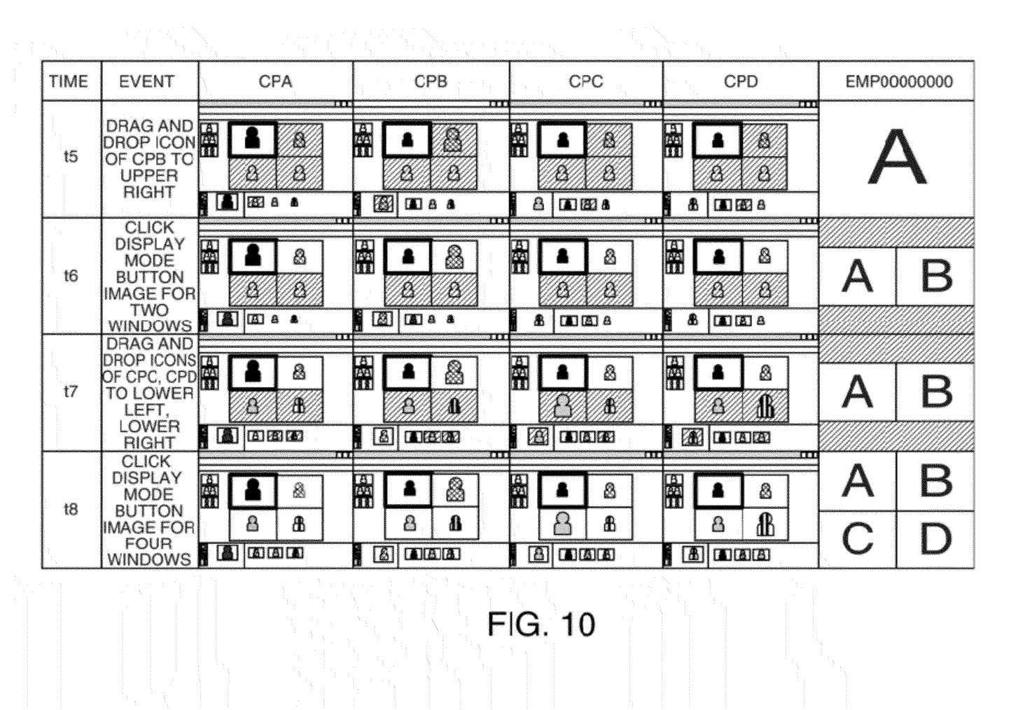

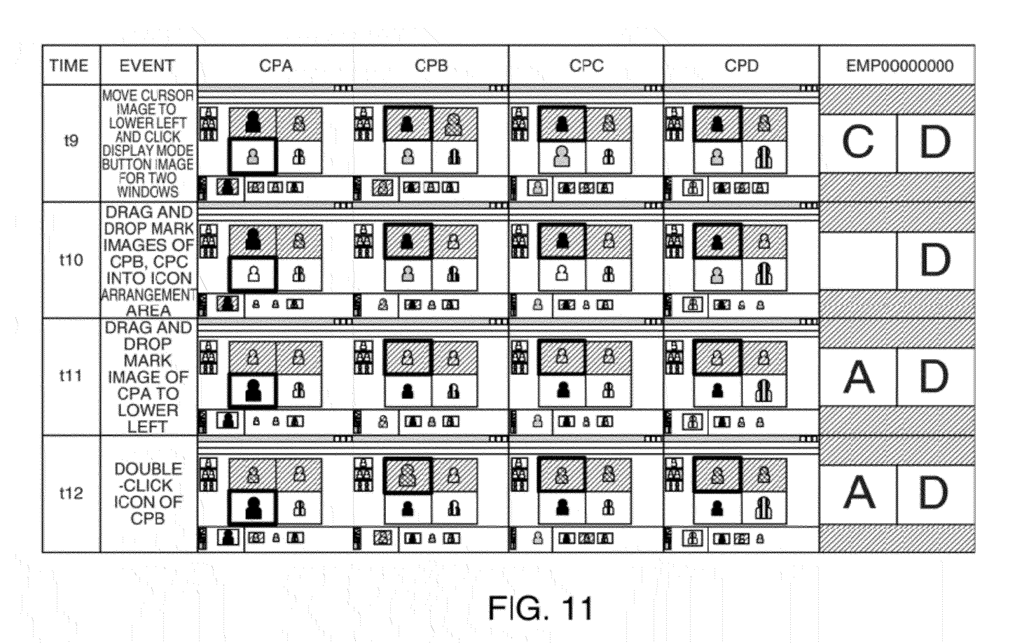

Here, image transitions in the projector 100 and the PCs 200-1 to 200-4 will be explained in more detail. FIG. 9 shows an example of image transitions in the respective apparatuses in the first embodiment. FIG. 10 shows another example of image transitions in the respective apparatuses in the first embodiment. FIG. 11 shows another example of image transitions in the respective apparatuses in the first embodiment. Here, for simplicity of explanation, it is assumed that the PC 200-1 (CPA) displays image A, the PC 200-2 (CPB) displays image B, the PC 200-3 (CPC) displays image C, and the PC 200-4 (CPD) displays image D. Further, the times t1 to t12 in the following description are continuous times.

At time t1, there is no PC 200 participating in the conference, and the projector 100 (EMP00000000) projects a single-color image. At time t2, when the CPA first participates in the conference, the projector 100 projects an overall image 20 containing image A of the CPA in response to the participation. On the other hand, at time t3, when the CPB participates, the projector 100 does not automatically project image B, but continues to project the overall image 20 containing image A of the CPA. Further, at time t4, when the CPC and the CPD participate, the projector 100 does not automatically project image C or image D, but continues to project the overall image 20 containing image A of the CPA. That is, the projector 100 automatically projects the image of the PC 200 that has first participated regardless of presence or absence of an explicit display instruction, however, does not project the images of the PCs 200 as the second and subsequent participants in the absence of an explicit display instruction.

At time t5, when a participant who operates the CPA drags and drops the icon of the CPB into the upper right area of the individual image arrangement area 530 in the configuration change image 500 displayed on the PC 200-1, the display mode remains in one window and the overall image 20 projected by the projector 100 does not change. Note that, if the icon is dragged and dropped from the icon arrangement area 540 into the individual image arrangement area 530, the icon remains in the icon arrangement area 540 and a mark image corresponding to the icon is added into the individual image arrangement area 530. At time t6, when the participant who operates the CPA clicks the display mode button image 512 for two windows in the configuration change image 500 displayed on the PC 200-1, the projector 100 projects the overall image 20 containing image A and image B corresponding to the mark images in the row position in which the cursor image 590 exists. Further, in this case, the background of the upper right display object area 532 of the individual image arrangement area 530 in each PC 200 changes from gray to white.

At time t7, when the participant who operates the CPA drags and drops the icon of the CPC into the lower left area of the individual image arrangement area 530 and drags and drops the icon of the CPD into the lower right area of the individual image arrangement area 530 in the configuration change image 500 displayed on the PC 200-1, the recess images in the display object areas 533, 534 of the respective PCs 200 change to mark images, however, the overall image 20 projected by the projector 100 does not change.

At time t8, when the participant who operates the CPA clicks the display mode button image 514 for four windows in the configuration change image 500 displayed on the PC 200-1, the projector 100 projects the overall image 20 containing image A, image B, image C, and image D corresponding to the respective mark images in the individual image arrangement area 530. Further, in this case, the backgrounds of the lower left display object area 533 and the lower right left display object area 534 in the individual image arrangement area 530 in each PC 200 change from gray to white, and the icon background images of the icons of the CPC, the CPD also change from gray to white.

At time t9, when the participant who operates the CPA moves the cursor image 590 into the lower left display object area 533 and clicks the display mode button image 512 for two windows in the configuration change image 500 displayed on the PC 200-1, the projector 100 projects the overall image containing image C and image D corresponding to the respective mark images in the individual image arrangement area 530. Further, in this case, the backgrounds of the upper left display object area 531 and the upper right left display object area 532 in the individual image arrangement area 530 in each PC 200 change from white to gray, and the icon background images of the icons of the CPA, the CPB also change from white to gray. Note that, since the cursor image 590 independently operates in each PC 200, even when the PC 200-1 moves the cursor image 590 as shown in FIG. 11, the cursor images 590 of the other PCs 200-2 to 200-4 do not move.

At time t10, when the participant who operates the CPA drags and drops the mark images of the CPB, the CPC into the icon arrangement area 540 in the configuration change image 500 displayed on the PC 200-1, the projector 100 turns the part where the image C has been to white and projects the overall image 20 containing image D. Further, in this case, the mark images disappear from the upper right display object area 532 and the lower left display object area 533 in the individual image arrangement area 530 in each PC 200, and the icon background images of the icons of the CPB, the CPC also disappear. Note that, the mark images disappear from the original locations by moving or drag-and-drop, and the recess images 580 are displayed in the display object areas without the mark images.

At time t11, when the participant who operates the CPA drags and drops the mark image of the CPA on the upper left into the display object area 533 on the lower left in the configuration change image 500 displayed on the PC 200-1, the projector 100 projects the overall image 20 containing image A and image D. Further, in this case, the icon background image of the icon of the CPA in the icon arrangement area 540 of each PC 200 changes from gray to white.

At time t12, when the participant who operates the CPA double-clicks the icon of the CPB with the mouse cursor superimposed on the icon of the CPB in the configuration change image 500 displayed on the PC 200-1, the mark image of the CPB is displayed in the upper left display object area 531 with the highest priority of empty areas where no mark image is provided among the display object areas 531 to 534, and the gray icon background image is added to the icon of the CPB. Note that, when a selectable icon within the icon arrangement area 540 is double-clicked with no empty area in the individual image arrangement area 530, the mark image in the lower right individual image arrangement area 534 with the lowest priority disappears and the mark image corresponding to the double-clicked icon is displayed in the display object area 534. Further, to the input unit 260, not only first operation information by normal drag-and-drop operation but also second operation information by double-click operation is input, and the terminal-side image generation unit 230 can generate the configuration change image 500 in response not only to the first operation information but also to the second operation information. Furthermore, the second operation information may be input from the keyboard connected to the PC 200-1. For example, if the participant selects an icon within the icon arrangement area 540 by the input using the TAB key of the keyboard, the icon may be highlighted and the mark image corresponding to the icon selected by the input using the Enter key of the keyboard may be displayed in the individual image arrangement area 530. In this case, the mouse cursor may not be necessarily superimposed on a desired icon. Since the icon may be selected by the simple keyboard operation, even a user who is inexperienced in operation of the pointing device can easily change the configuration of the overall image.

As described above, according to the embodiment, the PC 200 generates the image showing the icon 550 of the own terminal apparatus in the different form from those of the icons 552 to 556 of the other terminal apparatuses in the icon arrangement area 540, and thereby, the user becomes easier to operate the icon 550 of the own terminal apparatus that is more frequently operated than the icons 552 to 556 of the other terminal apparatuses. Thus, in the case where the overall image 20 containing the individual image based on the image information from the PC 200 by the projector 100, the operation for changing the configuration of the overall image 20 may be easier to be performed. Thereby, even in the case where the respective participants change the configuration of the overall image 20 using the respective PCs 200, the respective participants may efficiently perform desired operation.

Further, according to the embodiment, the PC 200 displays the icon 550 and the mark image 570 of the own terminal apparatus larger than the icons 552 to 556 and the mark images 572, 574 of the other terminal apparatuses, and thereby, the user becomes easier to operate the icon and the like of the own terminal apparatus that is more frequently operated than the icons and the like of the other terminal apparatuses. Further, according to the embodiment, the PC 200 displays the recess image 580 in the recessed state in the display object area 534 where the mark images 570 to 574 are not placed, and thereby, the user may think up the drag-and-drop operation more easily and grasp the destinations of the icons 550 to 556 than in the case where an image in a flat condition is displayed in the display object area 534. Furthermore, according to the embodiment, the PC 200 fixes the display location of the icon 550 of the own terminal apparatus, and thereby, the user becomes easier to operate the icon of the own terminal apparatus that is more frequently operated than the icons 552 to 556 of the other terminal apparatuses.

In addition, according to the embodiment, the PC 200 generates the configuration change image 500 containing the individual image arrangement area 530 showing the locations of the individual images 30 to 33 in the overall image 20 displayed by the projector 100, and thereby, may plainly present the configuration of the overall image 20. Further, according to the embodiment, the PC 200 displays the icon arrangement area 540 in which the icons resembling the participants are displayed with identification names (host names or the like) in the configuration change image 500, and thereby, the respective participants may grasp the current participants and may grasp the participants in a conference between distant places or the like. Furthermore, according to the embodiment, the PC 200 changes the display condition of the individual image arrangement area 530 in response to the operation, and thereby, even in the case where the configuration of the overall image 20 changes, the change may be promptly reflected on the display of the individual image arrangement area 530. Moreover, according to the embodiment, the PC 200 changes the icon background image on the background of the icon as the object of operation in response to the display condition of the individual image arrangement area 530, and thereby, the user becomes easier to visually grasp the display condition, and can perform prompt operation.

Further, according to the embodiment, the PC 200 changes the icon background image in response to the assignment condition of the mark image or the like, and thereby, the user becomes easier to operate when performing operation relating to the icon in response to the display condition. Furthermore, according to the embodiment, the PC 200 changes the icon background image to three different conditions in response to the three display conditions, and thereby, the user becomes easier to operate when performing operation relating to the icon in response to the display condition. In addition, according to the embodiment, the PC 200 determines whether or not the individual images are displayed based on operation information showing the location of the cursor image 590 and operation information showing press-down operations of the display button images 520 to 524, and thereby, the user may change the displays of the individual images by various operations, and may promptly change the configuration of the overall image 20.

Further, according to the embodiment, since the PC 200 also responds to the double-click operation as operation other than the drag-and-drop operation, in the case where the overall image 20 containing the individual images 30 to 33 based on the image information from the PC 200 is displayed by the projector 100, the operation for changing the configuration of the overall image 20 may be performed more easily. For example, the drag-and-drop operation may be difficult or may take time because the operation using a portable information terminal or the like is operation with a touch panel or the like, however, according to the embodiment, the user may change the configuration of the overall image 20 by the double-click operation (continuous touch operation), and, even in the case of using the portable information terminal or the like, the user may comfortably perform the desired operation. Furthermore, according to the embodiment, the PC 200 may place the mark image in response to the double-click operation with the mouse pointer superimposed on the icon, and the mark image may be placed automatically in the empty area.

In addition, according to the embodiment, the projector 100 displays the individual image based on the image information from the PC 200 that has first transmitted the participation request information regardless of the presence or absence of the explicit display instruction, and does not display the individual images based on the image information from the second and subsequent PCs 200 that have transmitted the participation request information in the absence of the explicit display instruction, but displays them in the presence of the explicit display instruction. Thus, even in the case where the participation requests or the like are received from the plural PCs 200, the projector may display the overall image appropriately and promptly. Further, for example, if the display apparatus displays the individual images based on the image information from the second and subsequent PCs 200 that have transmitted the participation request information, the configuration of the existing overall image changes and presentation or the like is inhibited. However, according to the embodiment, the projector 100 may receive the participation requests from the second and subsequent PCs 200 without changing the configuration of the existing overall image. On the other hand, for example, unless the display apparatus displays the individual images based on the image information from all of the PCs 200 that have transmitted the participation request information, the first PC 200 should always provide an explicit display instruction, and convenience is reduced. However, according to the embodiment, the projector 100 may immediately display the individual image based on the image information from the PC 200 that has first transmitted the participation request information, and the convenience may be improved.

Further, according to the embodiment, the projector 100 may appropriately display the overall image 20 by generating the overall image 20 based on the configuration change request information from the PC 200. Furthermore, according to the embodiment, the projector 100 may appropriately display the overall image 20 by using the image configuration data 144 etc. In addition, according to the embodiment, the projector 100 may notify the respective PCs 200 of the configuration of the overall image 20 and the participating PCs 200, and thus, the PC 200 may generate the configuration change image 500 reflecting the latest condition.

Further, according to the embodiment, the PC 200 may generate the configuration change image 500 reflecting the latest condition by using the image configuration data 244 etc. Furthermore, according to the embodiment, the PC 200 transmits the configuration change request information to the projector 100 in response to the operation relating to the configuration change, and thus, the projector 100 may change the configuration of the overall image 20 in response to the operation relating to the configuration change.

### Other Embodiments

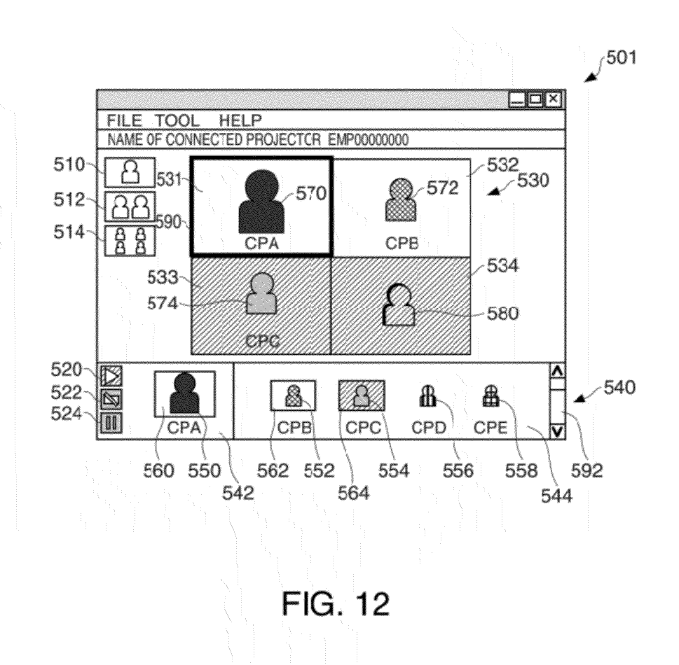

Note that the application of the invention is not limited to the above described embodiment, but modifications may be made. For example, the number of PCs 200 is not limited to four, but may be three or less or five or more. Further, the number of projectors 100 may be two or more. FIG. 12 shows an example of a configuration change image 501 in other embodiments. For example, in the case where the number of PCs 200 participating in the conference is six or more and only the icons to the icon 558 of the fifth CPE may be displayed in the other apparatus area 544, the terminal-side image generation unit 230 may generate the configuration change image 501 by adding a scroll bar image 592 into the other apparatus area 544 so that the icons of the sixth and the subsequent PCs 200 may be displayed in the other apparatus area 544 by scrolling of the scroll bar image 592.

Further, in the above described embodiment, the terminal-side image generation unit 230 changes the form of the icon background image in response to the display condition of the individual image arrangement area 530, however, may change the form of the icon. Furthermore, the change of the form is not limited to the change of color, but, for example, may be the change of pattern, the change of shape, the change of highlight effect by blinking or the like, etc.

In addition, the operation other than the drag-and-drop operation corresponding to the second operation information is not limited to the double-click operation, but, for example, may be operation by selection of an item in the menu displayed by right click of the mouse, key operation using the keyboard, contact operation using a touch panel of a portable information terminal or the like, etc. For example, the terminal-side updating unit 250 or the terminal-side information generation unit 220 may determine the display object areas in the individual image arrangement area 530 pointed by the user in response to the change of the contact position in the touch panel or the like (for example, the direction of movement, the direction and velocity of movement, the direction and amount of movement, or the like) based on the information from the input unit 260. For example, if the user moves the icon 550 to the left at a velocity equal to or more than a reference value (in an amount of movement equal to or more than a reference value) in the condition shown in FIG. 8, the terminal-side updating unit 250 may determine that the upper left display object area 531 is pointed, and, if the user moves the icon 550 to the left at a velocity less than the reference value (in an amount of movement less than the reference value), may determine that the lower left display object area 533 is pointed. Further, a method of determining the display object area in response to the second operation information is not limited to the method in response to the priority, however, for example, may be a method of randomly determining the area, a method of determining the display object area nearest the double-clicked icon, a method of determining the display object area in the position of the cursor image 590, a method of determining the area in response to the change of contact position, or the like.

In addition, the search image 400 and the configuration change image 500 may be images (for example, OSD images or the like) generated in different layers from those of the graphic images or the like to be image information, or images captured together with the graphic images or the like. Even in the case where the configuration change image 500 etc. are captured together with the graphic images or the like to the specifications of the OS or the like, the user may make the display of the configuration change image 500 or the like in the overall image 20 less noticeable by minimized display of the configuration change image 500 or the like or display on the right side so that the image may run off the edge of the screen of the PC 200. Particularly, the button images for operation are mainly provided on the left side in the configuration change image 500, and thus, even in the case where the configuration change image 500 is moved to the right to run off the edge of the screen, the button images for operation may be operated.

Further, as described above, the respective users can operate the icons or the like of the other PCs 200 in the configuration change images 500, 501 in their own PCs 200, however, they may perform different operations at the same time. For example, if contending operations are performed, the projector 100 can assign priority to the operation that has been first received or assign priority to the operation that has been last received using receipt numbers or the like.

Furthermore, the terminal-side communication unit 210 may transmits not only the image information but also voice information representing statements of participants or the like to the projector 100, and a voice output unit of the projector 100 may output voice based on the voice information.

In addition, the connection form of the projector 100 and the PC 200 is not limited to the wireless connection shown in FIG. 1, but may be wired connection using LAN or the like, for example. Further, the display apparatus is not limited to the projector 100, but may be a television, a liquid crystal monitor, electronic equipment having a projection function (for example, a digital camera, a cellular phone, or the like), for example. Furthermore, the terminal apparatus is not limited to the PC 200, but may be a cellular phone, a portable information terminal, or the like.

In addition, the computer of the projector 100 may read a program stored in an information storage medium and function as the display-side image generation unit 130 or the like. As the information storage medium, for example, a CD-ROM, a DVD-ROM, a ROM, a RAM, an HDD, or the like may be applied.

Further, the projector 100 is not limited to the liquid crystal projector (transmissive type, reflective type of LCOS or the like), however, for example, may be a projector using a digital micromirror device or the like. Furthermore, the projection unit 190 may employ a self-emitting devices including solid-state light sources such as an organic EL device, a silicon light emitting device, a laser diode, and an LED in place of the lamp. In addition, the function of the projector 100 may be distributed to plural apparatuses (for example, a PC and a projector or the like).

What is claimed is:

1. An information storage medium in which a program readable by a computer is stored, the program allowing the computer to execute:
generating a configuration change image containing an individual image arrangement area showing arrangement of an individual image in an overall image displayed by a display apparatus and an icon arrangement area containing an icon with respect to each terminal apparatus for changing a configuration of the overall image, the individual image is based on image information from one or more terminal apparatuses;
changing a display condition of the individual image arrangement area including an assignment condition of a mark image corresponding to the icon in the individual image arrangement area based on operation information representing operation relating to a configuration change of the overall image; and
changing an icon background image on a background of the icon or a form of the icon in the icon arrangement area in response to the display condition.

2. The information storage medium according to claim 1, wherein the individual image arrangement area is sectioned into plural display object areas,
in the display object area, the mark image is displayed or the mark image is deleted in response to operation for the icon or the mark image,
the display condition including a display condition in which the mark image is displayed and the individual image is displayed, a display-standby condition in which the mark image is displayed and the individual image is not displayed, and a non-display condition in which the mark image is not displayed.

3. The information storage medium according to claim 2, wherein the program allows the computer to execute:
displaying the icon background image in a first condition in the display condition;
displaying the icon background image in a second condition different from the first condition in the display-standby condition; and
displaying the icon background image in a third condition different from the first condition and the second condition in the non-display condition.

4. The information storage medium according to claim 2, wherein the configuration change image contains a cursor image moving in the respective display object areas in response to operation, and a display mode button image for designating a number of the individual images contained in the overall image, and
the program allows the computer to execute determining whether or not the individual image is displayed in the display condition based on the operation information representing a position of the cursor image and the operation information representing press-down operation of the display mode button image.

5. The information storage medium according to claim 1, wherein the program allows the computer to execute:
displaying an image showing an icon of an own terminal apparatus in a form different from that of an icon of another terminal apparatus in the icon arrangement area; and
displaying a mark image corresponding to an icon represented by the operation information in the individual image arrangement area based on the operation information.

6. The information storage medium according to claim 1, wherein the individual image arrangement area is segmented into plural display object areas, and
the program allows the computer to execute:
displaying the mark image in the display object area brought into correspondence with the icon according to the operation information,
displaying the icon of the own terminal apparatus larger than the icon of the other terminal apparatus in the icon arrangement area, and
displaying the mark image of the own terminal apparatus larger than the mark image of the other terminal apparatus in the individual image arrangement area.

7. The information storage medium according to claim 6, wherein the program allows the computer to execute:
displaying the icon of the own terminal apparatus in a color different from that of the icon of the other terminal apparatus in the icon arrangement area, and
displaying the mark image of the own terminal apparatus in a color different from that of the mark image of the other terminal apparatus in the individual image arrangement area.

8. The information storage medium according to claim 6, wherein the program allows the computer to execute determining colors of the respective icons and colors of the respective mark images based on condition notification information notified from the display apparatus or the other terminal apparatus.

9. The information storage medium according to claim 6, wherein the operation information includes information representing drag-and-drop operation for the icon from the icon arrangement area to the display object area, and
the program allows the computer to execute displaying an image in a recessed state in the display object area in which the mark image is not placed.

10. The information storage medium according to claim 5, wherein the program allows the computer to execute:
changing an initial display position of the icon of the other terminal apparatus in response to a connection sequence to the display apparatus; and
fixing a display position of the icon of the own terminal apparatus regardless of the connection sequence.

11. A terminal apparatus comprising:
an image generation unit that generates a configuration change image containing an individual image based on image information from one or more terminal apparatuses for changing a configuration of an overall image displayed by a display apparatus; and
an input unit to which operation information representing operation relating to a configuration change of the configuration change image is input,
wherein the configuration change image contains an individual image arrangement area showing arrangement of the individual image in the overall image and an icon arrangement area containing an icon with respect to each terminal apparatus,
the image generation unit changes a display condition of the individual image arrangement area including an assignment condition of a mark image corresponding to the icon in the individual image arrangement area based on the operation information, and changes an icon background image on a background of the icon or a form of the icon in the icon arrangement area in response to the display condition.

12. The terminal apparatus according to claim 11, wherein the image generation unit displays an image showing an icon of an own terminal apparatus in a form different from that of an icon of another terminal apparatus in the icon arrangement area, and displays a mark image corresponding to the icon represented by the operation information in the individual image arrangement area based on the operation information.

13. An image generation method of generating a configuration change image containing an individual image based on image information from one or more terminal apparatuses for changing a configuration of an overall image displayed by a display apparatus, the method comprising:
generating the configuration change image for containing an individual image arrangement area showing arrangement of the individual image in the overall image and an icon arrangement area containing an icon with respect to each terminal apparatus; and
when operation information representing operation relating to a configuration change of the configuration change image is input, changing a display condition of the individual image arrangement area including an assignment condition of a mark image corresponding to the icon in the individual image arrangement area based on the operation information, and changing an icon background image on a background of the icon or a form of the icon in the icon arrangement area in response to the display condition.

14. The image generation method according to claim 13, further comprising:
displaying an image showing an icon of an own terminal apparatus in a form different from that of an icon of another terminal apparatus in the icon arrangement area; and
based on the operation information representing addition of a new individual image to the overall image, displaying a mark image corresponding to the icon represented by the operation information in the individual image arrangement area.
